(19) United States
(12) Patent Application Publication
(10) Pub. No.: US 2026/0288392 A1
(43) Pub. Date: Sep. 24, 2026

(54) DATA CREATION METHOD, INFORMATION PROCESSING DEVICE, AND NON-TRANSITORY RECORDING MEDIUM

(71) Applicant: Casio Computer Co., Ltd., Tokyo (JP)

(72) Inventor: Saori MITOME, Tokyo (JP)

(73) Assignee: Casio Computer Co., Ltd., Tokyo (JP)

(21) Appl. No.: 19/571,875

(22) Filed: Mar. 19, 2026

(30) Foreign Application Priority Data
Mar. 24, 2025 (JP) 2025-048225

(51) Int. Cl. G06F 3/12

(52) U.S. Cl. CPC G06F 3/1243; G06F 3/1208; G06F 3/1256; G06F 3/1264

(57) ABSTRACT

A data creation method executed by a computer, includes: creating processing data for controlling an operation of a processing device including a cutter configured to cut a medium to be processed placed on a medium holding member, and creating processing data for cutting a print medium, on which a print image included in print data is printed by a printing device, as the medium to be processed placed on the medium holding member, based on a position of the print medium on the medium holding member when the print medium is placed on the medium holding member as the medium to be processed, and cut data for cutting at least one contour included in the print image generated by converting the print image.

### CROSS-REFERENCE TO RELATED APPLICATIONS

This application claims the priority and benefit of Japanese Patent Application No. 2025-048225 filed on Mar. 24, 2025. The entire specification, claims, and drawings of Japanese Patent Application No. 2025-048225 are incorporated herein by reference.

### TECHNICAL FIELD

The present disclosure relates to a data creation method, an information processing device, and a non-transitory recording medium.

### BACKGROUND

JP-A 2009-279702 discloses a processing device capable of processing a medium to be processed on the basis of processing data created by an external device such as a computer that executes a predetermined application.

### SUMMARY

A data creation method executed by a computer, including: creating processing data for controlling an operation of a processing device including a cutter configured to cut a medium to be processed placed on a medium holding member, and creating processing data for cutting a print medium, on which a print image included in print data is printed by a printing device, as the medium to be processed placed on the medium holding member, based on a position of the print medium on the medium holding member when the print medium is placed on the medium holding member as the medium to be processed, and cut data for cutting at least one contour included in the print image generated by converting the print image.

### BRIEF DESCRIPTION OF THE DRAWINGS

FIG. 1 is a diagram illustrating a relationship between an information processing device according to an embodiment and a label printer and a sheet cutter;

FIG. 2 is a diagram illustrating a configuration example of the information processing device according to the embodiment;

FIG. 3 is a sequence diagram illustrating an example of a method of data cooperation between a label application and a cut application;

FIG. 4A is a diagram illustrating an example of screen transition when print data created by the label application is stored;

FIG. 4B is a diagram illustrating an example of screen transition when print data created by the label application is stored;

FIG. 4C is a diagram illustrating an example of screen transition when print data created by the label application is stored;

FIG. 5 is a diagram illustrating a relationship between a print image and a print medium on which the print image is printed;

FIG. 6 is a flowchart illustrating an example of a label information storage process;

FIG. 7A is a diagram illustrating a mount used as a medium holding member of a processing device;

FIG. 7B is a diagram illustrating an edit screen of drawing data used for creating processing data;

FIG. 8A is a diagram illustrating a procedure of disposing a print image of a medium to be processed in drawing data;

FIG. 8B is a diagram illustrating a procedure of disposing the print image of the medium to be processed in the drawing data;

FIG. 9A is a diagram illustrating a procedure for adjusting a position of a medium to be processed of drawing data;

FIG. 9B is a diagram illustrating a procedure for adjusting the position of the medium to be processed of the drawing data;

FIG. 10 is a diagram illustrating drawing data in which the position of the medium to be processed is adjusted;

FIG. 11 is a diagram illustrating a processing example of a print medium as a medium to be processed by the processing device;

FIG. 12 is a diagram illustrating another processing example of the print medium as the medium to be processed by the processing device;

FIG. 13 is a sequence diagram illustrating another example of a method of data cooperation between a label application and a cut application; and

FIG. 14 is a flowchart illustrating a specific example of a cooperative object creation/storage process of FIG. 13.

### DETAILED DESCRIPTION

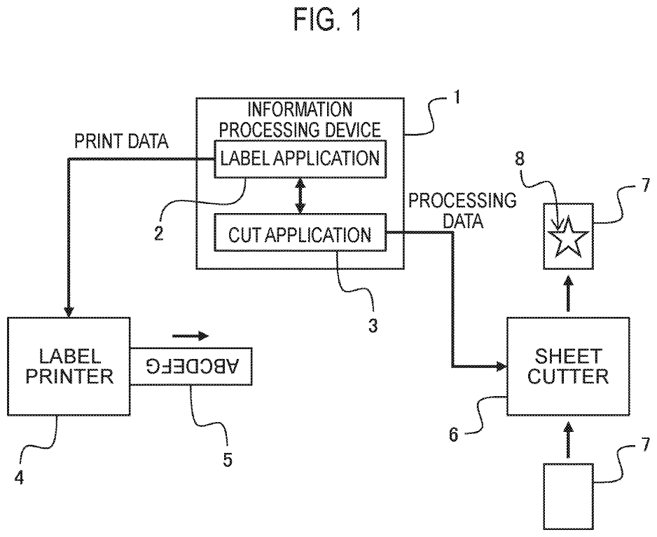

Hereinafter, embodiments of the present disclosure will be described with reference to the drawings. An information processing device 1 according to an embodiment illustrated in FIG. 1 can execute an application (label application 2) for creating print data to be transmitted to a label printer 4 and an application (cut application 3) for creating processing data (cut data) to be transmitted to a sheet cutter 6. The information processing device 1 may be, for example, a smartphone, a tablet computer, or another personal computer. The label printer 4 is a printing device that creates a label by printing on the print medium 5 based on print data. The print medium 5 may be a paper tape, a resin tape, or a sticker-like material having an adhesive layer on one main surface of a base material such as a resin tape. The sheet cutter 6 is a cutting device that cuts the medium to be processed 7 placed on a medium holding member (mount) based on the processing data (cut data). FIG. 1 illustrates an example in which the medium to be processed 7 is cut along a star-shaped pentagonal contour 8 set on the medium to be processed 7 based on the processing data. The label application 2 and the cut application 3 executed by the information processing device 1 cooperate such that the print data created by the label application 2 can be used for creating the processing data of the cut application 3. Unless otherwise specified, the term “processing data” in the following description intends cut data for controlling the operation of cutting the medium to be processed 7 by the sheet cutter 6.

The technique disclosed in JP 2009-279702 A has a problem that it is difficult to accurately cut a label created by a printing device with a cutting device. The present disclosure is intended to improve and solve the problem of such a situation, and is intended to improve processing accuracy when processing a print medium printed by a printing device by the processing device.

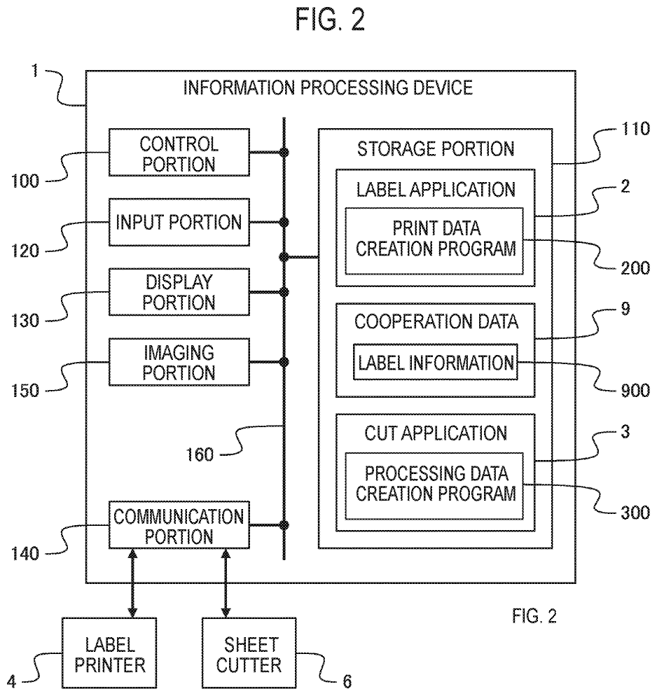

As illustrated in FIG. 2, the information processing device 1 includes a control portion 100, a storage portion 110, an input portion 120, a display portion 130, a communication portion 140, and an imaging portion 150, which can be mutually connected by a bus 160. The control portion 100 can be a processor such as a Central Processing Portion (CPU) as one or more processors that execute a control program for controlling the operation of the information processing device 1. The control program includes a print data creation program 200 of the label application 2 and a processing data creation program 300 of the cut application 3. The storage portion 110 stores the control program, created print data, processing data, and the like. The storage portion 110 can store part or all of the print data created by the label application 2 as label information 900 and store the label information 900 as one of cooperation data 9. The label information 900 includes an image (print image) to be printed on the print medium 5 and dimension information on the print medium 5 on which the image is to be printed. The storage portion 110 includes a Read Only Memory (ROM) and a Random Access Memory (RAM) as main storage devices, and auxiliary storage devices such as a Hard Disk Drive (HDD) and a Solid State Drive (SSD). The input portion 120 can be an input device such as a switch or a keyboard for inputting various types of information regarding the operation of the information processing device 1. The display portion 130 can be a display device such as a lamp or a display that visualizes and displays various types of information including the operation state of the information processing device 1. The display portion 130 may be a touch panel display having the function of the input portion 120. The communication portion 140 may be a communication device capable of communicating with the label printer 4 and communicating with the sheet cutter 6. The communication portion 140 may be capable of either or both of wireless communication conforming to a short-range wireless communication standard such as Bluetooth Low Energy (registered trademark) and wired communication via a transmission cable such as a Universal Serial Bus (USB) cable. The imaging portion 150 can be a camera that captures an image of an article outside the information processing device 1. In the information processing device 1, the imaging portion 150 may be omitted as long as a camera that is an external device can be connected by a transmission cable or the like.

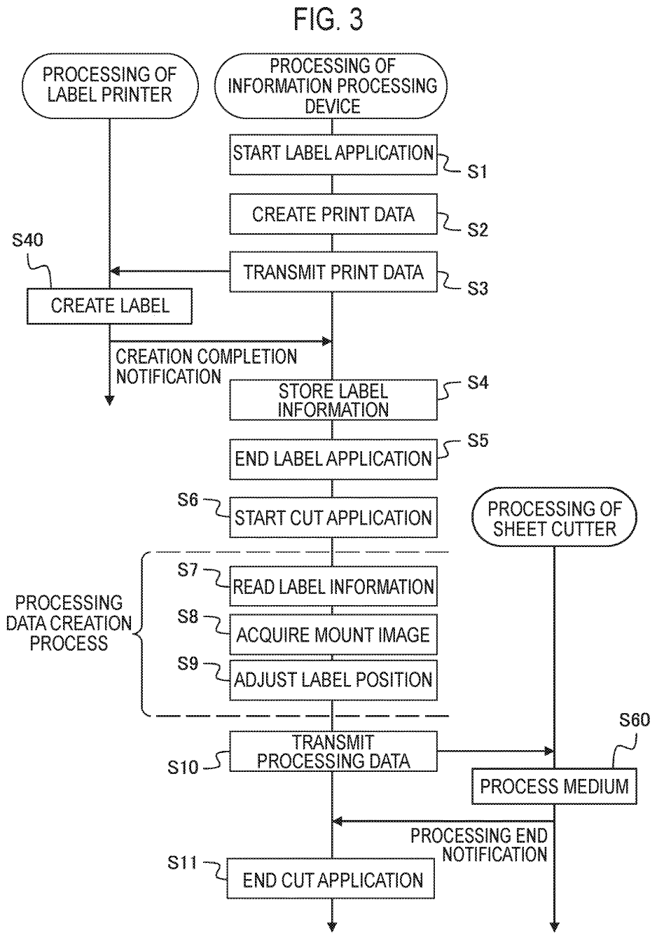

The sheet cutter 6 cuts the medium to be processed 7 by changing a relative position between a cutter (processing portion) that cuts the medium to be processed 7 and a medium holding member (mount) on which the medium to be processed 7 is placed based on the processing data. The medium to be processed 7 may be a label (print medium 5 on which an object is printed) created by the label printer 4. A procedure when the user of the information processing device 1 according to the embodiment causes the sheet cutter 6 to cut the label created by the label printer 4 as the medium to be processed 7 will be described with reference to FIGS. 3 to 10. In the following description, detailed description of well-known operations, processes, operations, and the like of the label application 2, the label printer 4, the cut application 3, and the sheet cutter 6 will be omitted.

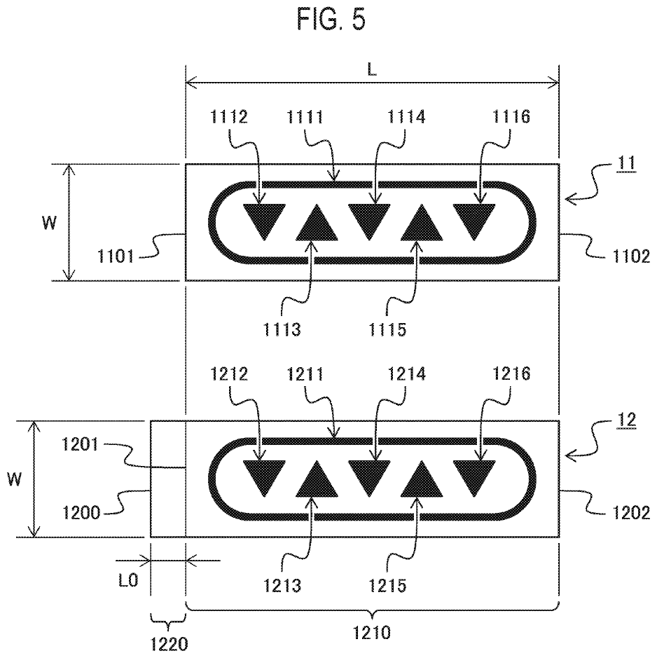

The processing of the information processing device in FIG. 3 is mainly performed by the control portion 100 of the information processing device 1. When detecting a predetermined user operation associated with the start of the label application 2, the control portion 100 starts the label application 2 (step S1). Thereafter, the control portion 100 can create print data according to a user operation (step S2) and transmit the created print data to the label printer 4 (step S3). The print data can include, for example, image information such as the print image 11 illustrated in FIG. 5 and information on dimensions (width W and length L) of the print image 11. The width W of the print image 11 is a width of the print medium 5 on which the print image 11 is printed by the label printer 4, and is a dimension in a direction orthogonal to the conveyance direction of the print medium 5 in the label printer 4. The length L of the print image 11 is the length of the print medium 5 on which the print image 11 is printed by the label printer 4, and is the dimension in the conveyance direction of the print medium 5 in the label printer 4. The label printer 4 that has received the print data from the information processing device 1 can print the print data on the print medium 5 based on the received print data to create a label (step S40). The label printer 4 prints the print image 11 on the surface of the print medium 5 while conveying the print medium 5 having the width W attached to the label printer 4 in the direction of the length L, and creates the label 12 as illustrated in FIG. 5. The label printer 4 may be capable of cutting positions corresponding to the left end 1101 and the right end 1102 of the print image 11 on the print medium 5 with a built-in cutter. In a case where the print medium 5 is of a sticker type having a base material and an adhesive layer, the created label 12 may have a label main body 1210 corresponding to the print image 11 and a leading margin 1220 adjacent to the left side (head side in the conveyance direction) of the label main body 1210. In this example, the label 12 is created in which the left end 1201 of the leading margin 1220 and the right end 1202 of the label main body 1210 are cut with the cutter. At a boundary 1201 between the label main body 1210 and the leading margin 1220 corresponding to the left end 1101 of the print image 11, only the base material and the adhesive layer on the print medium 5 are cut, and the label main body 1210 and the leading margin 1220 are integrally held by release paper for protecting the adhesive layer.

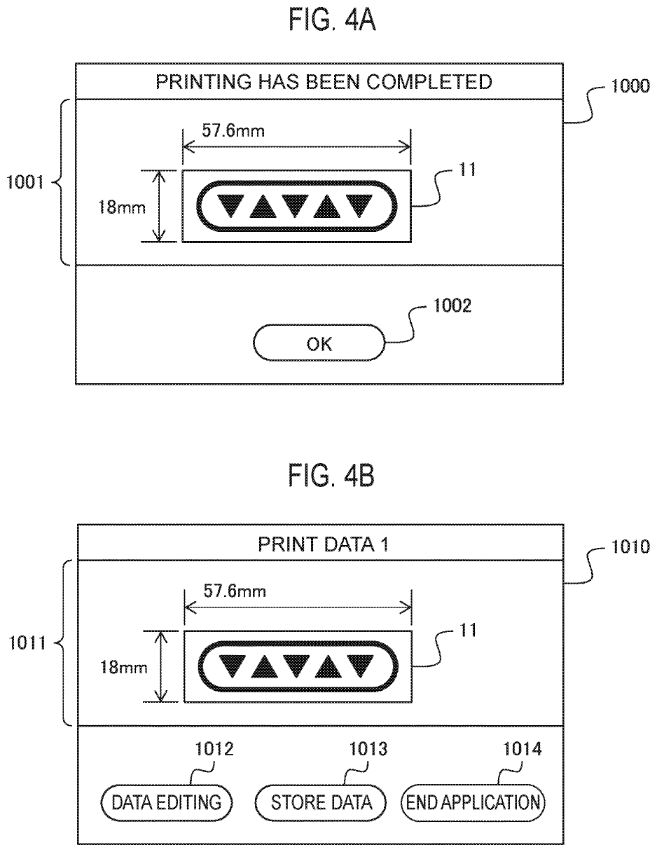

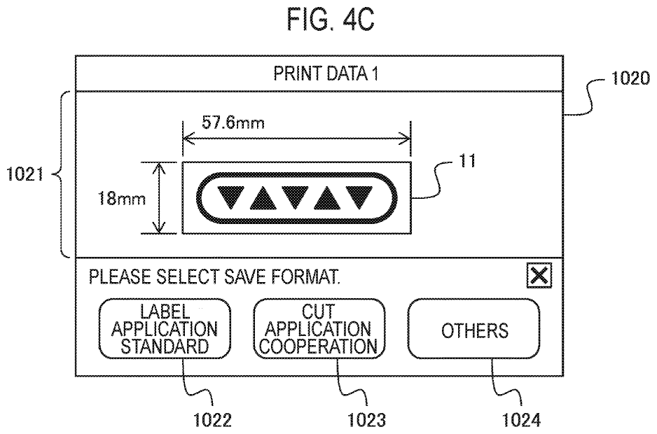

When the process of creating a label (step S40) is completed, the label printer 4 transmits a creation completion notification to the information processing device 1. For example, after receiving the creation completion notification, the information processing device 1 can store the label information including the print image 11 and the dimension information (step S4). The control portion 100 of the information processing device 1 that has received the creation completion notification causes the display portion 130 to display the completion notification screen 1000 illustrated in FIG. 4A, for example. The completion notification screen 1000 and other screens referred to in the following description may be displayed in the entire display area of the display portion 130, or may be displayed in a partial area of the entire display area. The completion notification screen 1000 includes a preview area 1001 and a confirmation button 1002. In the preview area 1001, the print image 11 included in the print data transmitted to the label printer 4 and information on dimensions (width W and length L) of the print image 11 are displayed. In FIG. 4A, width W=18 mm and length L=57.6 mm are displayed as specific examples of the dimensions of the print image 11. When the user presses the confirmation button 1002, the control portion 100 can display the processing selection screen 1010 illustrated in FIG. 4B on the display portion 130, for example. The processing selection screen 1010 includes a preview area 1011 and selection buttons 1012 to 1014. In the preview area 1011 of the processing selection screen 1010, the same information as the preview area 1001 of the completion notification screen 1000 is displayed. When the user presses the first selection button 1012, the control portion 100 causes the display portion 130 to display an edit screen of the print image 11 displayed in the preview area 1011.

When the user presses the second selection button 1013 on the processing selection screen 1010, the control portion 100 causes the display portion 130 to display a save format selection screen 1020 illustrated in FIG. 4C, for example. The save format selection screen 1020 includes a preview area 1021 and selection buttons 1022 and 1023. In the preview area 1021 of the save format selection screen 1020, information on the print image 11 displayed in the preview area 1011 when the second selection button 1013 on the processing selection screen 1010 is pressed is displayed. When the user presses the first selection button 1022 on the save format selection screen 1020, the control portion 100 causes the storage portion 110 to store the information on the print image 11 displayed in the preview area 1021 in the standard save format in the label application 2. When the user presses the second selection button 1023 on the save format selection screen 1020, the control portion 100 causes the storage portion 110 to store the information on the print image 11 displayed in the preview area 1021 in a format that can cooperate with the cut application 3 (step S4 in FIG. 3). In this case, the storage portion 110 stores label information 900 including a print image and dimension information. The print image in the label information 900 may be raster data (for example, JPEG or the like) or vector data of the print image 11 displayed in the preview area 1021 of the save format selection screen 1020. The dimension information may be dimensions (for example, W=18 mm, L=57.6 mm) of the print image 11. When the user presses the third selection button 1024 on the save format selection screen 1020, another storage method of the information on the print image 11 can be selected (designated). The storage method that can be selected (designated) may be, for example, a method of storing as a PDF file, but is not limited to the storage method associated with such a data format. For example, the selectable storage method may be a method of attaching to an e-mail, or the like.

When the user presses the third selection button 1014 on the processing selection screen 1010 illustrated in FIG. 4B, the control portion 100 ends the label application 2 (step S5 in FIG. 3). In step S5, for example, before ending the label application 2, the control portion 100 may determine whether or not the latest information regarding the print image 11 displayed in the preview area 1011 is stored in the storage portion 110. In this example, when it is determined that the latest information is not stored, the control portion 100 may inquire of the user whether or not to store the latest information regarding the print image 11. When detecting a user operation for selecting to store the latest information, the control portion 100 causes the display portion to display the save format selection screen 1020 as illustrated in FIG. 4C.

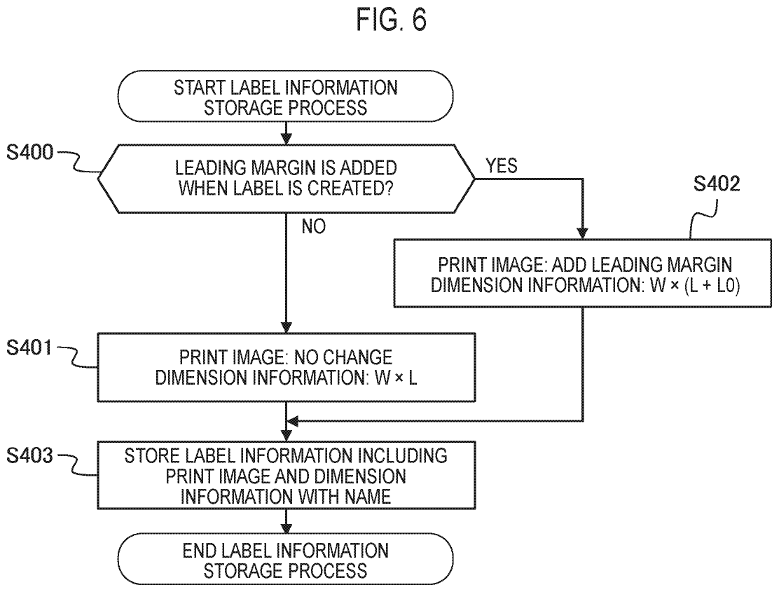

Note that the label printer 4 can create a label in which the leading margin 1220 is added to the label main body 1210 that can have the same size as the dimension of the print image 11, like the label 12 described above with reference to FIG. 5. The process of storing the label information in the label application 2 for this type of label printer 4 (step S4 in FIG. 3) can be specifically, for example, the process illustrated in FIG. 6. First, the control portion 100 determines whether a leading margin 1220 is added when a label is created (step S400). When the leading margin 1220 is not added (step S400; NO), the control portion 100 does not change the print image 11 (that is, the print image 11 is used as the print image of the label information 900), and sets the dimensions (width W, length L) of the print image 11 as the dimension information of the label information 900 (step S401). When the leading margin 1220 is added (step S400; YES), the control portion 100 sets the image obtained by adding the image of the leading margin 1220 to the print image 11 as the print image of the label information 900, and sets the dimensions (width W, length L+L0) obtained by adding the dimension of the leading margin 1220 to the print image 11 (label main body 1210) as the dimension information of the label information 900 (step S402). After step S401 or S402, the control portion 100 names the label information 900 including the determined print image and the dimension information, and stores (saves) the label information in the storage portion 110 (step S403). By performing such a process, the print image and the dimension information included in the label information 900 can be matched with the print image and the dimension information of the label (for example, label 12 of FIG. 5) created by the label printer 4.

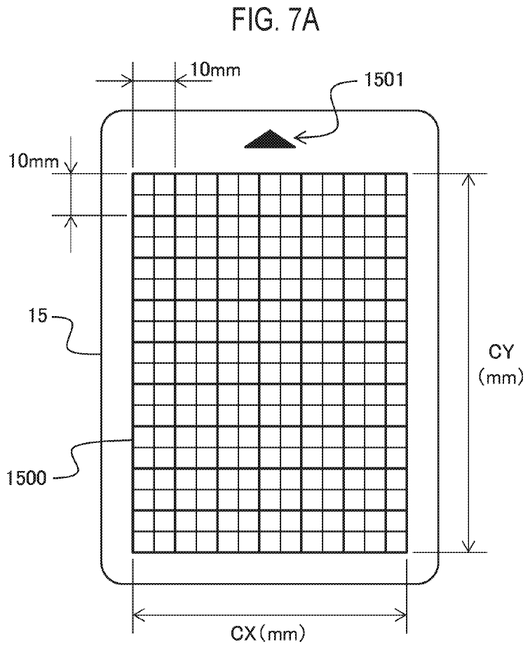

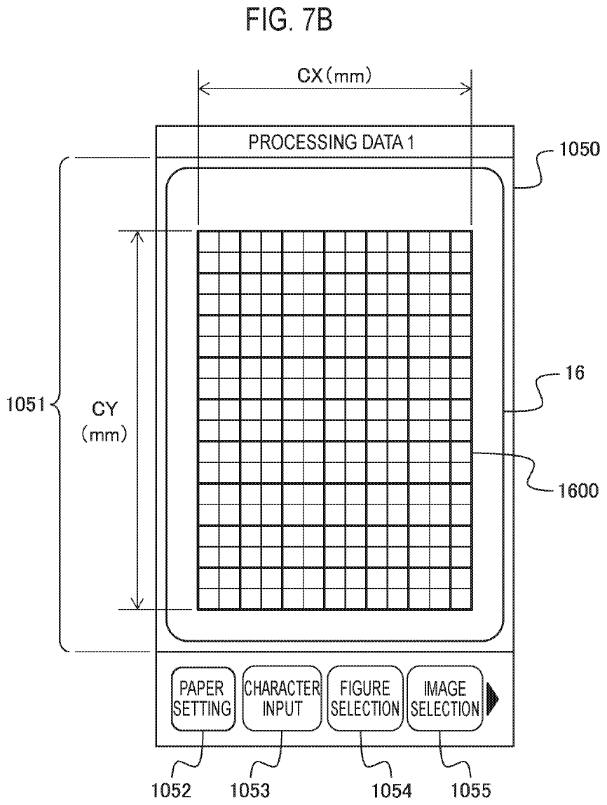

After ending the label application 2 in step S5 of FIG. 3, the user can start the cut application 3. Note that the information processing device 1 may be able to start and execute the cut application 3 while executing the label application 2. When detecting a predetermined user operation associated with the start of the cut application 3, the control portion 100 of the information processing device 1 starts the cut application 3 (step S6). Thereafter, the control portion 100 can perform a processing data creation process of creating processing data in accordance with a user operation. In the processing data creation process, the information processing device 1 that executes the cut application 3 according to the embodiment can read label information and display a label on the edit screen (step S7), acquire an image of a mount (medium holding member) on which the created label is placed (step S8), and adjust a position of the label displayed on the edit screen (step S9). When the medium to be processed 7 is cut by the sheet cutter 6 based on the processing data created by the cut application 3, the medium to be processed 7 is placed on, for example, a mount 15 (medium holding member) as illustrated in FIG. 7A. On a surface of the mount 15 on which the medium to be processed 7 is placed, a cuttable area 1500 where the medium to be processed 7 is cuttable by a cutter of the sheet cutter 6 and a mark 1501 indicating an orientation in which the mount 15 is set on the sheet cutter 6 are displayed. The cuttable area 1500 is divided into a grid pattern by grid lines that can be used to grasp the position and dimension in the area. FIG. 7A illustrates an example in which the area is divided into a grid pattern of 5 mm square with the upper left corner of the cuttable area 1500 as the origin. After starting the cut application 3 for creating processing data to be transmitted to the sheet cutter 6 using such a mount 15, the control portion 100 can display, for example, an edit screen 1050 as illustrated in FIG. 7B on the display portion 130.

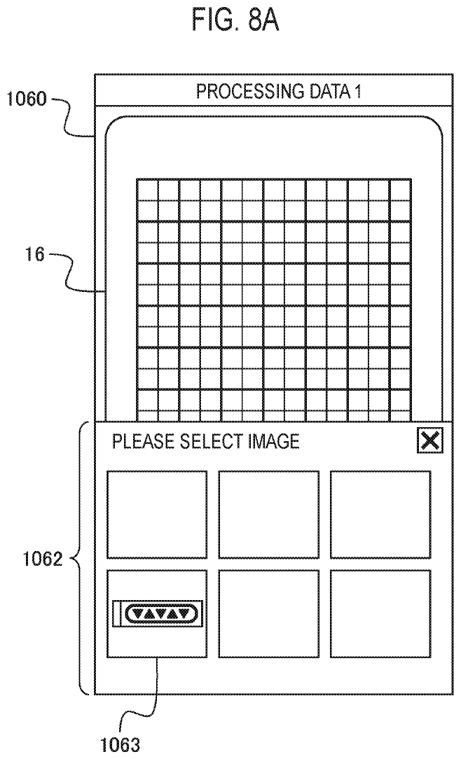

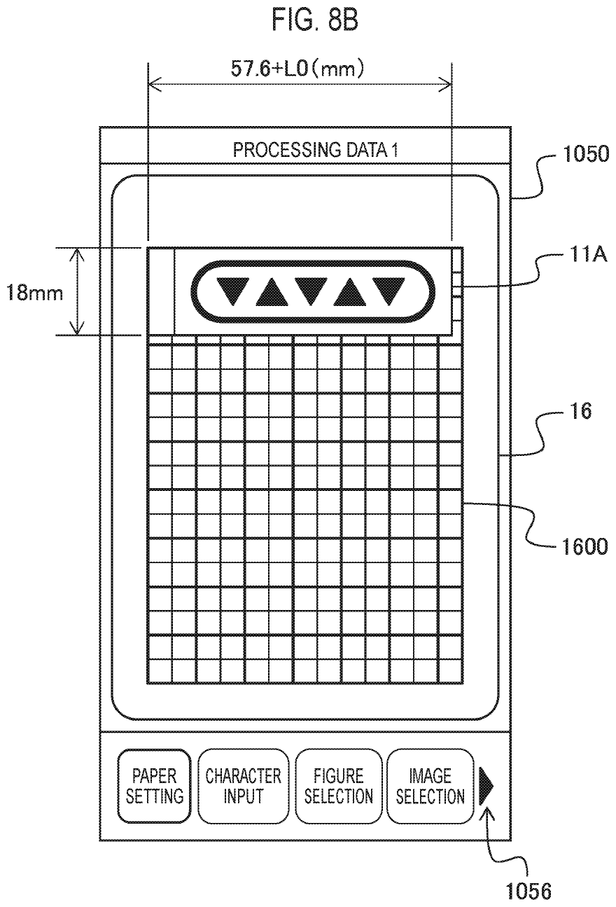

The edit screen 1050 includes an edit area 1051 and a selection area where selection buttons 1052 to 1055 and the like are displayed. In the edit area 1051, a mount image 16 that can be image data of the entire surface on which the medium to be processed 7 is placed in the mount 15 set in the sheet cutter 6 is displayed. In practice, with respect to the cuttable area 1600 of the mount image 16 in FIG. 7B, the cuttable area 1500 of the mount 15 illustrated in FIG. 7A is likely to be enlarged or reduced in accordance with the display dimension of the edit area 1051 but the dimension of one square is 5 mm square, so that the user can easily grasp the position and dimension in the cuttable area 1600 of the mount image 16 displayed in the edit area 1051. When the user presses the first selection button 1052 on the edit screen 1050, the control portion 100 can receive a user operation of selecting a dimension, a position, and the like of the paper (the medium to be processed 7) to be placed in the cuttable area 1600 in the mount image 16 on the edit screen 1050. When the user presses the second selection button 1053, the control portion 100 can receive a user operation of inputting characters on the paper of the edit screen 1050. When the user presses the third selection button 1054, the control portion 100 can receive a user operation of selecting a figure to be placed on the paper of the edit screen 1050. When the user presses the fourth selection button 1055, the control portion 100 can receive a user operation of selecting an image to be placed in the cuttable area 1600 in the mount image 16 on the edit screen 1050 (step S7 of FIG. 3). When detecting a user operation of pressing the fourth selection button 1055, the control portion 100 causes the display portion 130 to display an image selection screen 1060 as illustrated in FIG. 8A, for example.

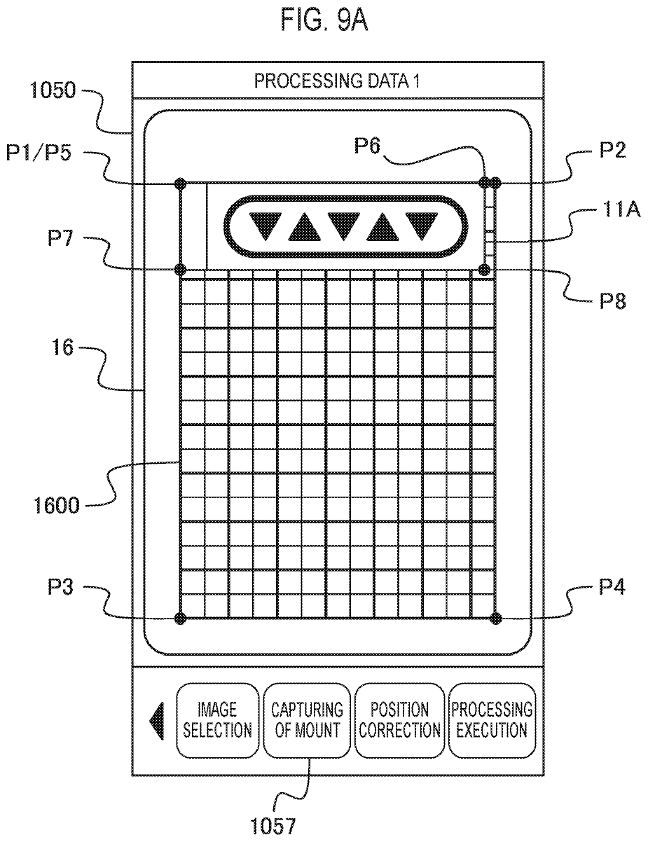

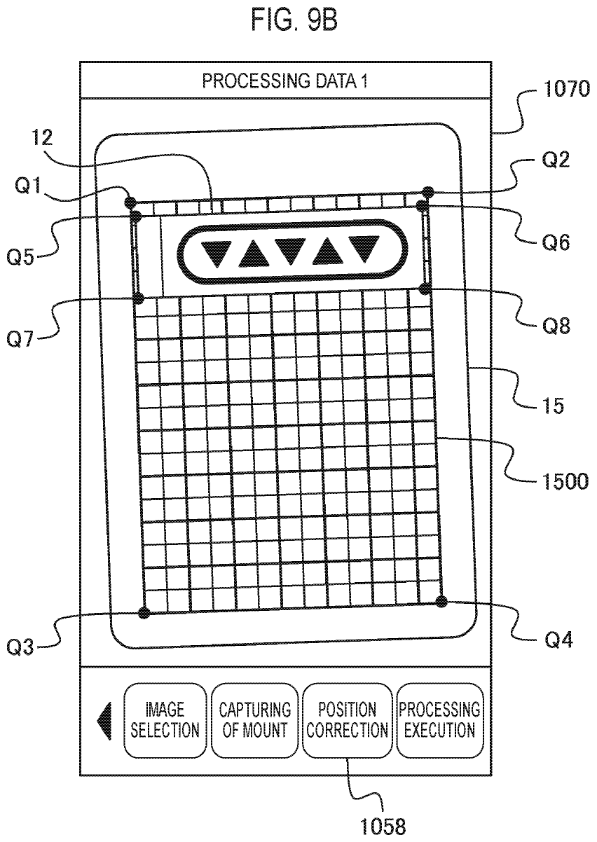

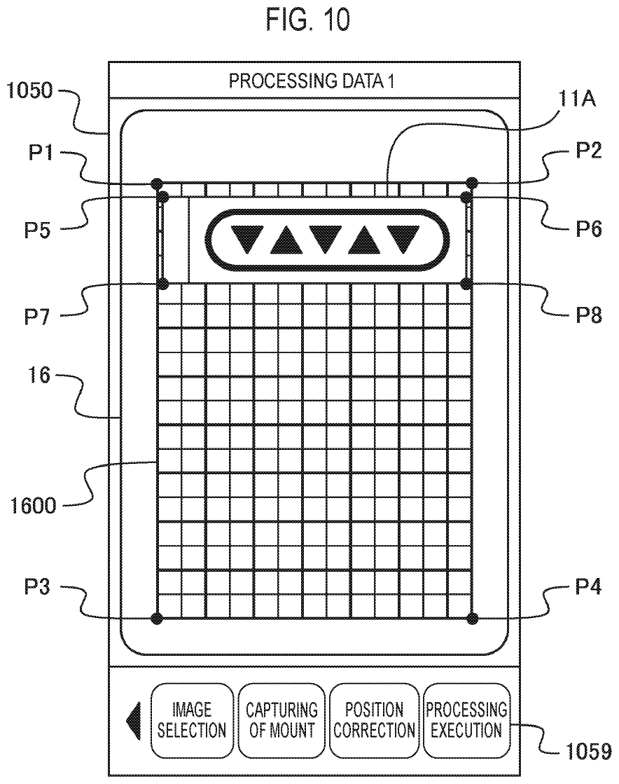

The image selection screen 1060 can be a screen in which an image list display area 1062 is superimposed in front of the edit screen 1050 on which the mount image 16 is displayed. In the image list display area 1062, an image that can be read by the cut application 3 or a thumbnail of the image is displayed. When the above-described label information 900 is stored in the storage portion 110, the thumbnail 1063 of the print image (for example, a print image of the label 12 of FIG. 5) included in the label information 900 is displayed in the image list display area 1062. When the user performs an operation of selecting an image or a thumbnail, the control portion 100 displays the selected image in the cuttable area 1600 of the mount image 16 on the edit screen 1050. When the selected image is the print image of the label information 900, the control portion 100 places the print image as drawing data in the cuttable area 1600. For example, when the selected print image is the print image 11A (thumbnail 1063) of the label 12 in FIG. 5, the control portion 100 disposes the print image 11A in the cuttable area 1600 of the mount image 16 such that the upper left corner of the print image 11A is the upper left corner of the cuttable area 1600 of the mount image 16. In this case, the control portion 100 adjusts the dimension of the print image 11A to be disposed, based on the dimension information associated with the selected print image and the dimension (grid line interval) of the cuttable area 1600 of the mount image 16 on the edit screen 1050. After reading the label information 900 and displaying the print image 11A on the front surface of the mount image 16, for example, when a selection item switching button 1056 on the edit screen 1050 in FIG. 8B is pressed, for example, as illustrated in FIG. 9A, the selection button displayed below the mount image 16 on the edit screen 1050 is changed. When the user presses a selection button 1057 of “capturing of mount” on the edit screen 1050 in FIG. 9A, the control portion 100 performs a process of acquiring an image of the mount 15 on which the label 12 is placed (step S8 in FIG. 3). In step S8, the control portion 100 activates the imaging portion (camera) 150, and displays a live view and a shutter button of the imaging portion 150 on the display portion 130. When the user presses the shutter button, the control portion 100 causes the display portion 130 to display the image acquired from the imaging portion 150 when the shutter button is pressed. Thereafter, when the user agrees to use the image displayed on the display portion 130 as the image of the mount 15, the control portion 100 causes the display portion 130 to display a mount screen 1070 including the image of the mount 15 as illustrated in FIG. 9B, for example. In this case, the positional relationship between the cuttable area 1500 and the label 12 on the mount screen 1070 is not likely to match the positional relationship between the cuttable area 1600 and the print image 11A on the edit screen 1050 illustrated in FIG. 9A. In a case where the position of the print image 11A on the mount image 16 of the edit screen 1050 does not match the position of the label 12 on the mount 15 set on the sheet cutter 6, the label 12 cannot be cut correctly. Therefore, in the cut application 3 according to the embodiment, it is possible to perform a position adjustment process (step S9 in FIG. 3) for matching the position of the print image 11A in the cuttable area 1600 on the edit screen 1050 with the position of the label 12 in the cuttable area 1500 on the mount 15. When the user presses a selection button 1058 of “position correction” on the mount screen 1070 in FIG. 9B, the control portion 100 first performs a correction process for matching the shape and orientation of the mount 15 on the mount screen 1070 with the shape and orientation of the mount image 16 on the edit screen 1050. This correction process can include known trapezoid correction and rotation processing. The control portion 100 corrects the shape of the cuttable area 1500 such that the relationship between the positions and the distances of the four corners Q1 to Q4 in the cuttable area 1500 of the mount screen 1070 matches the relationship between the positions and the distances of the four corners P1 to P4 in the cuttable area 1600 of the edit screen 1050 in FIG. 9A. In this case, the control portion 100 also corrects the positions of the four corners Q5 to Q8 of the label 12 in the cuttable area 1500 in accordance with the correction of the shape of the cuttable area 1500. After correcting the shapes of the cuttable area 1500 and the label 12, the control portion 100 corrects the positional relationship between the corners P1 to P4 of the cuttable area 1600 and the corners P5 to P8 of the print image 11A on the edit screen 1050 in FIG. 9A, based on the positional relationship between the corrected corners Q1 to Q4 of the cuttable area 1500 and the corrected corners Q5 to Q8 of the label 12. By this process, for example, as illustrated in FIG. 10, the position of the print image 11A in the cuttable area 1600 of the mount image 16 on the edit screen 1050 can be matched with the position of the label 12 in the cuttable area 1500 of the mount 15. As described above, by correcting the position of the print image 11A in the cuttable area 1600 of the edit screen 1050 using the image of the mount 15 on which the label 12 is placed, the user can place the label 12 on the mount 15 without worrying about the accuracy of the position, for example. An adhesive layer for preventing deviation of the medium to be processed 7 such as the label 12 during processing (cutting) is disposed in the cuttable area 1500 of the mount 15. For example, when the label 12 is repeatedly peeled off from the adhesive layer of the mount 15 in order to place the label 12 at a correct position, deterioration of the adhesive layer of the mount 15, deterioration of the label 12, and the like may occur. By correcting the position of the print image 11A in the cuttable area 1600 of the edit screen 1050 by the cut application 3 according to the embodiment, the number of times of peeling the label 12 from the adhesive layer of the mount 15 can be reduced, and deterioration of the adhesive layer of the mount 15, deterioration of the label 12, and the like can be prevented.

After the position of the print image 11A in the cuttable area 1600 of the mount image 16 on the edit screen 1050 is determined by the processing in steps S7 to S9 described above, when the user presses a selection button 1059 of “execute processing” on the edit screen 1050 in FIG. 10, the control portion 100 transmits processing data to the sheet cutter 6 (step S10). The sheet cutter 6 that has received the processing data from the information processing device 1 performs a process of cutting the label 12 (the medium to be processed 7) placed on the mount 15 based on the received processing data (step S60 in FIG. 3). The sheet cutter 6 cuts the label 12 under known control based on the processing data. When the process of cutting the label 12 is ended, the sheet cutter 6 transmits a processing end notification to the information processing device 1. The control portion 100 of the information processing device 1 that has received the processing end notification causes the display portion 130 to display a screen for notifying the user that the cutting of the label 12 has ended. Thereafter, when the user performs a predetermined operation for ending the cut application 3, the control portion 100 ends the cut application 3 (step S11 in FIG. 3).

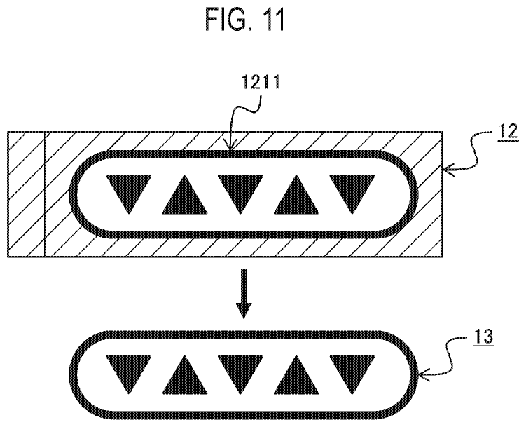

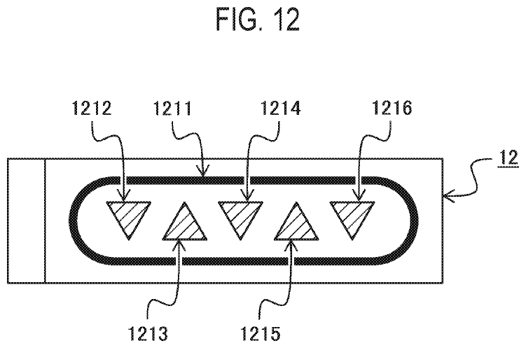

When creating the cut data (processing data) of the label 12 by the cut application 3, the information processing device 1 according to the above-described embodiment disposes the print image 11A created by the label application 2 on the mount image 16 of the edit screen 1050 as an image of the label 12 to be placed on the mount 15. In addition, the cut application 3 according to the embodiment corrects (adjusts) the positional relationship between the corners P1 to P4 of the cuttable area 1600 of the mount image 16 and the corners P5 to P8 of the print image 11 on the edit screen 1050, based on the positional relationship between the corners Q1 to Q4 of the cuttable area 1500 and the corners Q5 to Q8 of the label 12 in the image of the mount 15 on which the label 12 is placed, and creates processing data. In a case where processing data of the label 12 is created by the cut application 3 in the related art, drawing data of the label on the mount image 16 that serves as the basis for processing data is created from, for example, an image of the label 12 captured by the imaging portion (camera) 150 or the like of the information processing device 1. However, in the image of the label 12 captured by the camera, the contour of the object printed on the label 12 may not accurately reflect the contour in the print image 11A due to the level of light reflected by the label 12, the angle of the label 12 with respect to the imaging surface at the time of capturing, and the like. Therefore, when the processing data is created from the image of the label 12 captured by the camera and the label 12 is cut, a part of the cutting line may deviate from the contour of the object of the label 12, and this reduces the processing accuracy, such as making the cutting lines less smooth. For example, as illustrated in FIG. 11, when the label 12 is cut along the contour on the outer peripheral side of the oval object 1211 to cut out an oval label 13, the cutting line of the curved portion of the object 1211 may not have a smooth arc shape. On the other hand, the position and shape of the object in the print image 11 disposed on the mount image 16 on the edit screen 1050 of the cut application 3 according to the embodiment accurately correspond to the position and shape of the object printed on the label 12. Therefore, when the label 12 is cut on the basis of the processing data created by the cut application 3 according to the embodiment, a curved portion in the contour of the object 1211 printed on the label 12 can be smoothly cut, and the processing accuracy is improved. Furthermore, the information processing device 1 according to the embodiment can generate the processing data in which the contour of the object in the print images 11 and 11A is set as the cutting position on the basis of the raster data (for example, JPEG or the like) such as the print images 11 and 11A created by the label application 2 or the vector data. Therefore, it is possible to meet a request from a user of the information processing device 1 who may be a user of the cutting device (sheet cutter 6) to accurately cut the label 12 created by the printing device (label printer 4) with the cutting device. When creating the processing data, the cut application 3 according to the embodiment can select a contour to be cut out of a plurality of contours of the object disposed on the medium to be processed on the edit screen 1050 by a user operation. The contour of the object disposed on the medium to be processed can be extracted by a known contour extraction method. The processing data is created based on the position of the print image 11A disposed on the mount image 16 of the edit screen 1050 and cut data including information indicating the contour to be cut out of the contours of the object of the print image. For example, when the processing data for cutting the label 12 illustrated in FIG. 5 is created, as illustrated in FIG. 12, processing data for cutting only the contour of the triangular objects 1212 to 1216 arranged in the oval object 1211 can be created. The label 12 illustrated in FIG. 12 can be used as a label in which hatched regions in the triangular objects 1212 to 1216 are removed and triangular holes are opened. Therefore, for example, the label 12 can be superimposed and pasted on an article having a color different from that of the label 12, on another label, or the like, so that the label can look like a multi-color printed label.

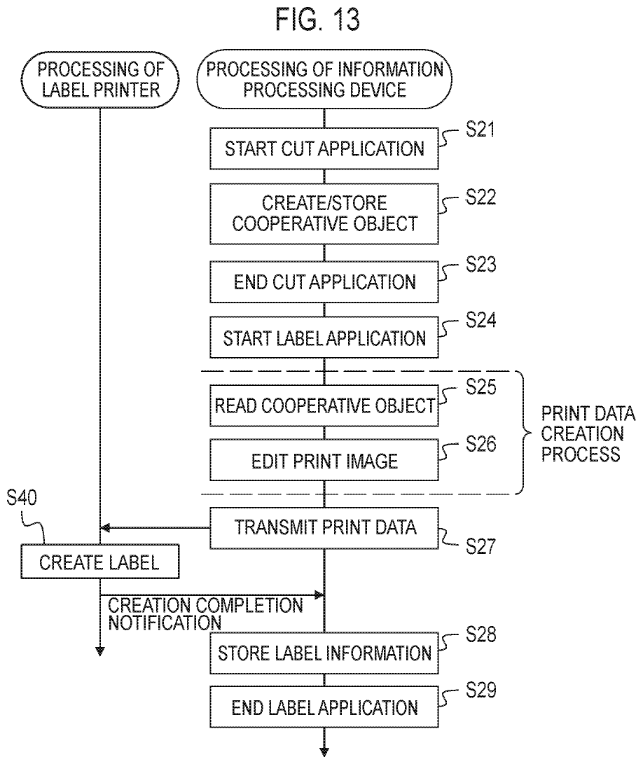

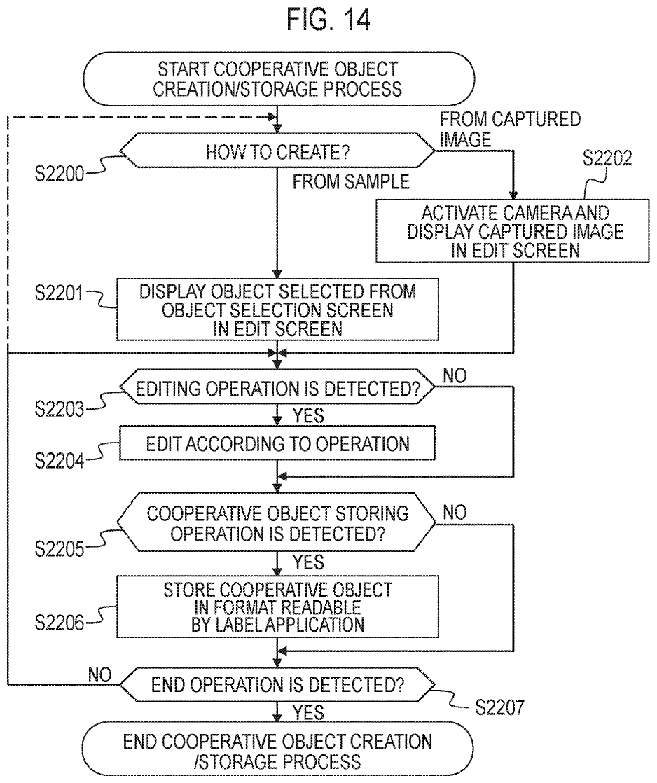

The label application 2 and the cut application 3 according to the embodiment described above may cooperate not only such that the label information 900 including the print image and the dimension information created by the label application 2 can be used in the cut application 3, but also such that data created in the cut application 3 can be used in the label application 2. For example, the label application 2 prepares, as preset data (sample data), several objects (figures) having designability that can be used to create the print image 11. However, the number of types of such objects in the label application 2 is small, and it is often difficult to improve the designability of the label 12. On the other hand, the cut application 3 can create processing data from an object such as a figure with high designability drawn by a user operation and an image captured by a camera, and cut the medium to be processed 7 so as to cut out the object. Therefore, it is possible to create the label 12 having high designability by performing data cooperation such that data of the object having high designability created by the cut application 3 can be used by the label application 2. A procedure when the label application 2 creates the label 12 using the object created by the cut application 3 will be described with reference to FIGS. 13 and 14.

The processing of the information processing device in FIG. 13 is mainly performed by the control portion 100 of the information processing device 1. When detecting a predetermined user operation associated with the start of the cut application 3, the control portion 100 starts the cut application 3 (step S21). Thereafter, the control portion 100 can create and store a cooperative object that can also be used by the label application 2 in response to a user operation (step S22). In step S22, the control portion 100 can perform, for example, the processing illustrated in FIG. 14. First, the control portion 100 causes the user to select a creation method of the cooperative object (step S2200). The creation method may include a method of creating from a sample object of the cut application 3 and a method of creating from an image captured by the camera. In a case where the user selects the method of creating from a sample object (step S2200; from the sample), the control portion 100 displays the object selected from an object selection screen in the edit screen of the display portion 130 (step S2201). In a case where the user has selected the method of creating from the image captured by the camera (step S2200; from the captured image), the control portion 100 activates the imaging portion (camera) 150 to display the captured image in the edit screen of the display portion 130 (step S2202). Note that the creation method may include, for example, a method of newly creating drawing data of an object using the drawing function of the cut application 3, a method of reading an image stored in the storage portion 110 and creating, and the like. The image stored in the storage portion 110 may be an image of an object created in the past by the cut application 3 or another drawing application, an image captured in the past by the imaging portion 150, an image acquired via a communication network such as the Internet, or the like.

After step S2201 or S2202, when the control portion 100 detects an operation of editing the object or the image displayed on the edit screen (step S2203; YES), the object or the image is edited according to the detected operation (step S2204). The editing operation may be, for example, enlargement, reduction, rotation, inversion of an object, extraction of an object in an image, or the like. When no editing operation has been detected (step S2203; NO), and the operation of storing the cooperative object is detected (step S2205; YES), the control portion 100 stores the cooperative object in the storage portion 110 in a format readable by the label application 2 (step S2206). After steps S2203 to S2206, when the control portion 100 detects an operation for ending creation of the cooperative object (step S2207; YES), the cooperative object creation/storage process of FIG. 14, which can be a specific example of step S22 of FIG. 13, ends. When the operation for ending the creation of the cooperative object has not been detected (step S2207; NO), the control portion 100 makes the determination in step S2203, for example. When the cooperative object is stored in step S2206, the control portion 100 may perform the determination in step S2200 after the determination in step S2207. When detecting the predetermined operation by the user after the end of step S22 in FIG. 13, the control portion 100 ends the cut application 3 (step S23).

After ending the cut application 3, the user can start the label application 2. Note that the information processing device 1 may be able to start and execute the label application 2 while executing the cut application 3. When detecting a predetermined user operation associated with the start of the label application 2, the control portion 100 of the information processing device 1 starts the label application 2 (step S24). Thereafter, the control portion 100 can perform print data creation process of creating print data according to a user operation. In the print data creation process, the control portion 100 can read the cooperative object stored in the storage portion 110 and display the cooperative object on the edit screen (step S25), and can edit the print image displayed on the edit screen (step S26). In step S25, the control portion 100 can cause the display portion 130 to display a list of the objects and the cooperative objects included in the preset data of the label application 2 and display the cooperative object selected by the user on the edit screen. In step S26, for example, the user can change the dimensions of the cooperative object on the basis of the dimensions (width W, length L) of the print image displayed on the edit screen, and change the position of the cooperative object in the print image. In step S26, it may be possible to input characters in the print image and read other objects to change dimensions and positions. The print data creation process may include a process of performing settings regarding the number of labels to be created, cutting of the print medium 5, and the like. When a user operation for executing label creation is detected during the print data creation process, the control portion 100 transmits print data including the created print image to the label printer 4 (step S27). In step S27, the control portion 100 transmits, to the label printer 4, print data including, for example, the print image 11 of FIG. 5, information regarding the presence or absence of the leading margin 1220, and the like, the number of times of printing (the number of labels to be created), and information on settings regarding cutting of the print medium 5. The label printer 4 that has received the print data from the information processing device 1 can print the print data on the print medium 5 based on the received print data to create a label (step S40). When the process of creating a label (step S40) is completed, the label printer 4 transmits a creation completion notification to the information processing device 1. For example, after receiving the creation completion notification, the information processing device 1 can store the label information including the print image 11 and the dimension information (step S28). The processing in step S28 may be the same as the processing in step S4 in FIG. 3 described above. When detecting the predetermined operation by the user after step S28, the control portion 100 ends the label application 2 (step S29). Thereafter, the user can start and execute the cut application 3 to cut the label created by the label printer 4, for example. As described above, the label application 2 and the cut application 3 according to the embodiment can bidirectionally implement data cooperation that enables data created by one application to be used by the other application. Therefore, the label created by the printing device can be cut with high accuracy by the cutting device, and in addition, the degree of freedom of the design of the label that can be created by the printing device is increased, and the user convenience is improved.

The above-described embodiments are specific examples to facilitate understanding of the invention, and the present disclosure is not limited to the above-described embodiments. Various modifications and changes of the program, the information processing device, and the control method can be made without departing from the scope of the claims. For example, the label printer 4 and the sheet cutter 6 described above are merely examples of a combination of a printing device that performs printing on the print medium 5 based on print data including a print image and a cutting device that cuts the print medium 5 on which the print image has been printed by the printing device as a medium to be processed. The print medium 5 in the printing device is not limited to a tape-shaped medium, and may be a sheet-shaped medium of any size. Furthermore, the print medium 5 is not limited to a sticker type medium having an adhesive layer.

Furthermore, for example, when disposing the print image read from the storage portion 110 in step S7 of FIG. 3 on the mount image 16 of the edit screen, the orientation of the print image may be changed on the basis of the dimensions (for example, the length L) of the print image. On the edit screen 1050 of FIG. 8B, the length L=57.6+L0 (mm) of the print image 11A is smaller than the dimension in the lateral direction of the cuttable area 1600 of the mount image 16. However, the length L of the print image may be larger than the dimension in the lateral direction (X direction) of the cuttable area 1600 of the mount image 16. Therefore, when the length L of the print image is larger than the dimension in the lateral direction of the cuttable area 1600, for example, the print image may be rotated by 90 degrees and disposed in the cuttable area 1600. Furthermore, when the length L of the print image is larger than the dimension in the longitudinal direction of the cuttable area 1600 of the mount image 16, for example, when the label application 2 stores the label information 900 or when the cut application 3 reads the label information 900, the user may be notified that the print image protrudes from the cuttable area 1600. In addition, the label application 2 and the cut application 3 described as separate applications in the above-described embodiment may be incorporated as a label creating function and a medium cutting function in a single medium processing application. In this example, for example, the information processing device 1, the label printer 4, and the sheet cutter 6 may be integrated.

What is claimed is:

1. A data creation method executed by a computer, comprising:
creating processing data for controlling an operation of a processing device including a cutter configured to cut a medium to be processed placed on a medium holding member; and
creating processing data for cutting a print medium, on which a print image included in print data is printed by a printing device, as the medium to be processed placed on the medium holding member, based on a position of the print medium on the medium holding member when the print medium is placed on the medium holding member as the medium to be processed, and cut data for cutting at least one contour included in the print image generated by converting the print image.

2. The data creation method according to claim 1, wherein
the print data includes information on dimensions of the print medium on which the print image is printed,
the method further comprising:
acquiring an image of the medium holding member on which the print medium, on which the print image is printed, is placed;
specifying the position of the print medium on the medium holding member in the acquired image of the medium holding member; and
adjusting a position of the print image disposed on the image of the medium holding member in drawing data generated to create the cut data, based on the specified position of the print medium on the medium holding member and the information on dimensions of the print medium included in the print data.

3. The data creation method according to claim 2, wherein
the medium holding member is provided with a mark serving as a guide of a position where the medium to be processed is placed on a surface on which the medium to be processed is placed,
the position specifying includes specifying a positional relationship between the mark of the medium holding member and a position of a corner of the print medium in the image of the medium holding member acquired in the image acquisition process, and
the position adjusting includes adjusting the position of the print image on the image of the medium holding member in the drawing data such that a positional relationship between the mark on the medium holding member and the corner of the print image in the drawing data coincides with the positional relationship specified in the position specifying process.

4. The data creation method according to claim 3, wherein
the medium holding member is provided with a frame line indicating a cuttable area where the medium to be processed is cuttable by the cutter of the processing device on a surface on which the medium to be processed is placed, and
the mark of the medium holding member is a corner of the frame line.

5. The data creation method according to claim 3, wherein
the cuttable area of the medium holding member is divided into a plurality of squares in a grid pattern by a plurality of grid lines drawn at predetermined intervals, and
the position specifying includes specifying the positional relationship between the mark of the medium holding member and the position of the corner of the print medium, based on a distance from the mark in the image of the medium holding member acquired in the image acquisition process to the corner of the print medium, the distance being derived using the predetermined interval and an interval of the grid line in the image of the medium holding member acquired in the image acquisition process.

6. The data creation method according to claim 4, wherein
the cuttable area of the medium holding member is divided into a plurality of squares in a grid pattern by a plurality of grid lines drawn at predetermined intervals, and
the position specifying includes specifying the positional relationship between the mark of the medium holding member and the position of the corner of the print medium, based on a distance from the mark in the image of the medium holding member acquired in the image acquisition process to the corner of the print medium, the distance being derived using the predetermined interval and an interval of the grid line in the image of the medium holding member acquired in the image acquisition process.

7. An information processing device comprising:
one or more processors each of which creates processing data for cutting a print medium, on which a print image included in print data is printed by a printing device, as a medium to be processed placed on a medium holding member, based on a position of the print medium on the medium holding member when the print medium is placed on the medium holding member as the medium to be processed, and cut data for cutting at least one contour included in the print image generated by converting the print image.

8. The information processing device according to claim 7, wherein the print data includes information on dimensions of the print medium on which the print image is printed, and
the one or more processors:
acquire an image of the medium holding member on which the print medium, on which the print image is printed, is placed;
specify a position of the print medium on the medium holding member in the acquired image of the medium holding member; and
adjust a position of the print image disposed on the image of the medium holding member in drawing data generated to create the cut data, based on the specified position of the print medium on the medium holding member and the information on dimensions of the print medium included in the print data.

9. The information processing device according to claim 8, wherein
the medium holding member is provided with a mark serving as a guide of a position where the medium to be processed is placed on a surface on which the medium to be processed is placed,
the position specifying includes specifying a positional relationship between the mark of the medium holding member and a position of a corner of the print medium in the image of the medium holding member acquired in the image acquisition process, and
the position adjusting includes adjusting the position of the print image on the image of the medium holding member in the drawing data such that a positional relationship between the mark on the medium holding member and the corner of the print image in the drawing data coincides with the positional relationship specified in the position specifying process.

10. The information processing device according to claim 9, wherein
the medium holding member is provided with a frame line indicating a cuttable area where the medium to be processed is cuttable by a cutter of a processing device on a surface on which the medium to be processed is placed, and
the mark of the medium holding member is a corner of the frame line.

11. The information processing device according to claim 9, wherein
the cuttable area of the medium holding member is divided into a plurality of squares in a grid pattern by a plurality of grid lines drawn at predetermined intervals, and
the position specifying includes specifying a positional relationship between the mark of the medium holding member and the position of the corner of the print medium, based on a distance from the mark in the image of the medium holding member acquired in the image acquisition process to the corner of the print medium, the distance being derived using the predetermined interval and an interval of the grid line in the image of the medium holding member acquired in the image acquisition process.

12. The information processing device according to claim 10, wherein
the cuttable area of the medium holding member is divided into a plurality of squares in a grid pattern by a plurality of grid lines drawn at predetermined intervals, and
the position specifying includes specifying a positional relationship between the mark of the medium holding member and the position of the corner of the print medium, based on a distance from the mark in the image of the medium holding member acquired in the image acquisition process to the corner of the print medium, the distance being derived using the predetermined interval and an interval of the grid line in the image of the medium holding member acquired in the image acquisition process.

13. A computer-readable non-transitory recording medium that records a program for causing a computer that creates processing data for controlling an operation of a processing device including a cutter configured to cut a medium to be processed placed on a medium holding member, to execute a process of:
creating processing data for cutting a print medium, on which a print image included in print data is printed by a printing device, as the medium to be processed placed on the medium holding member, based on a position of the print medium on the medium holding member when the print medium is placed on the medium holding member as the medium to be processed, and cut data for cutting at least one contour included in the print image generated by converting the print image.
